(19) United States
(12) Patent Application Publication
(10) Pub. No.: US 2013/0022390 A1
(43) Pub. Date: Jan. 24, 2013

(54) Adapter device of tandem bicycle

(71) Applicant: BOR CHING LIN, New Taipei (TW)

(72) Inventor: BOR CHING LIN, New Taipei (TW)

(73) Assignee: BIPEACE ENTERPRISE CO., LTD, New Taipei (TW)

(21) Appl. No.: 13/188,479

(22) Filed: Jul. 22, 2011

(51) Int. Cl. F16C 11/12

(52) U.S. Cl. 403/58

(57) ABSTRACT

The creation is an adapter device for tandem bicycle. The tandem bicycle consists of the bicycle and the connected bicycle. The adapter device comprises the universal joint and twist apparatus. The universal joint is connected to the scheduled placed of the seat tube, so the reaction force caused by rugged roads can be eliminated by the device when riders make a turn. About the twist apparatus, which links the connected bicycle, the flexible components in the twist apparatus can make the preceding part of bicycle more stable at the start or at low speed in riding, so the bicycle can have good stability and mobility, and is easy to ride.

### FIELD OF THE INVENTION

The creation is an adapter device, and it can make the tandem bicycle keep the mobility and stability of one-seat bicycle.

### BACKGROUND OF THE INVENTION

With the evolution of bicycle, many different kinds of bicycles appear. Some are for energy-saving purpose, and some are for leisure and entertainment purpose. Furthermore, a traditional one-seat bicycle can be transformed into a two-seat or larger tandem bicycle for amusement and energy-saving function.

Although riding a tandem bicycle can bring more fun, it may be difficult for actual practice. As riders' paces are not identical, and riders could interfere with each other. If one rider, for example, rides the bicycle harder, the balance of the bicycle could be destroyed, and the chain of bicycle may not operate smoothly. Furthermore, the structure of tandem bicycle may make the body of bicycle become longer, and it may not be easy to make a turn or it may affect the balance in riding. Even, it will increase risks and difficulties in riding if people ride the bicycle at a low speed.

Therefore, solving the above problem and improving the mentioned defects are the purpose and research direction of the creator of the adapter device and related manufacturers in the industry.

### SUMMARY OF THE INVENTION

The purpose of the creation is to combine the mobility of one-seat bicycle and the stability of tricycle. The above purpose can be reached by the creation. The creation is an adapter device for tandem bicycle. The adapter device combines the bicycle and the connected bicycle. The adapter consists of the universal joint and the twist apparatus. The universal joint includes the first axle and the second axle. The first axle is connected to the scheduled place of the seat tube of bicycle. The flexible component in the twist apparatus is used to connect the second axle. The second axle goes through the fixer. The fixer is used to interfere with the connecting rod, which is limited by flexible component, and is connected to the schedule place of connected bicycle by the twist apparatus. When people start their bicycle riding or ride bicycles at low speed, the adapter device can make the bicycle more stable and improve the unbalance problem about left and right deviation. Therefore, it can increase the safety of the tandem bicycle.

The universal joint in the creation can eliminate the reaction force when a rider makes a turn on a tandem bicycle or eliminate the reaction force caused by rugged roads. When the centrifugal force is larger than the torque limitation in riding at high speed, the universal joint can let the bicycle make a turn stably to further improve the safety of tandem bicycle.

The use of twist apparatus in the creation can improve the stability of preceding body, and thereby enhances the mobility of tandem bicycle.

The effect of the creation: Under low speed (5 km/h˜0), when the preceding body of bicycle can not keep balance, the twist apparatus in the creation has the function of torque limit to prevent the bicycle from tilting, so this way will keep the stability of tricycle.

The effect of the creation: Under medium speed (10˜5 km/h), when the preceding body of bicycle can not be controlled well, the twist apparatus can use the function of torque limitation to assist the balance of bicycle and improve the stability of tricycle.

The effect of the creation : Under high speed (above 10 km/h), when there is demand of “lateral tilt” in the preceding body of bicycle, even the torque is over the limitation, it won't affect the mobility of tandem bicycle.

No matter under stopped status, low speed, medium speed, or high speed, the creation can keep the balance of bicycle, and has a complete function.

### BRIEF DESCRIPTION OF THE FIGURES

FIG. 1 is the actual optimum status of the use of the creation.

FIG. 2 is the partial enlarged status of the creation.

FIG. 3 is the further enlarged status of the creation.

FIG. 4 is the section of the creation.

FIG. 5 is the actual operational status 1.

FIG. 6 is the actual operational status 2

FIG. 7 is the section of another creative twist apparatus

FIG. 8 is the unfolded diagram of the creative whole bicycle.

FIG. 9 is the folded diagram of the creative whole bicycle.

### DETAILED DESCRIPTION OF THE INVENTION

In order to reach to the above purpose and function, the features of technology and structure, which are adopted in the creation, are well explained by the figures.

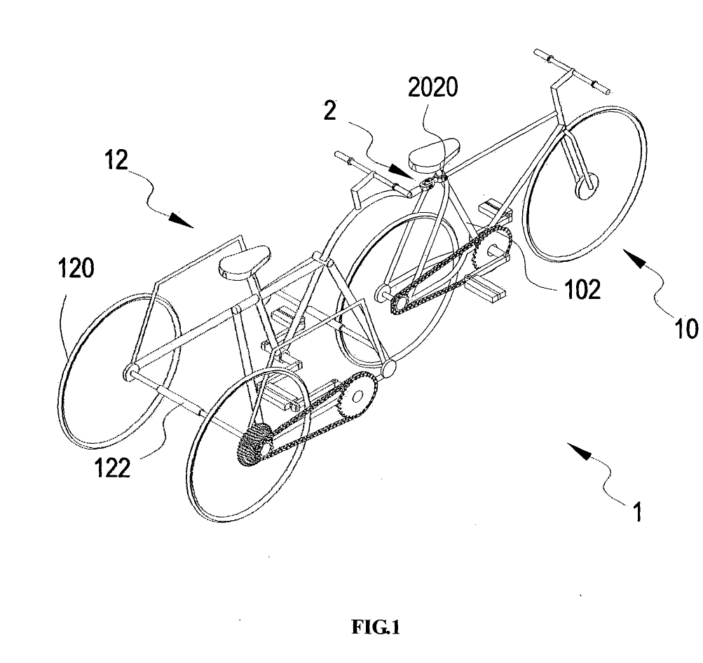

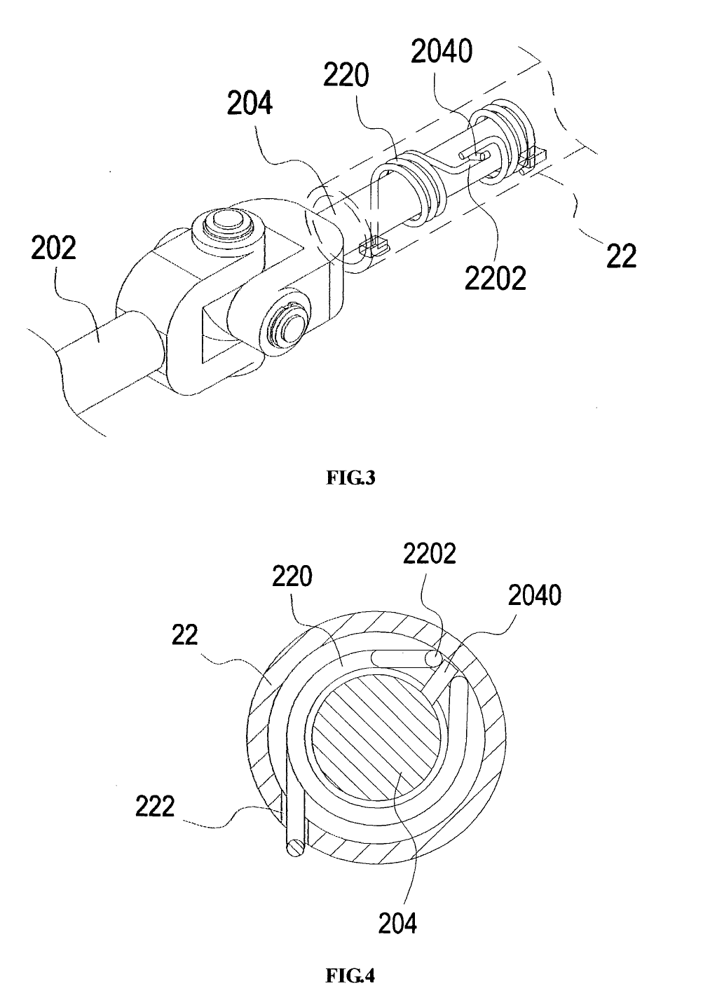

According to the FIGS. 1, 2, 3, and 4, they separately represent the actual optimum status of the use of the creation, partial enlarged status of the creation, further enlarged status of the creation, and section of the creation. From those figures, it's easy to know that the creation is an adapter device for tandem bicycle. The tandem bicycle (1) consists of the bicycle (10) and the connected bicycle (12). The adapter device (2) includes the universal joint (20) and the twist apparatus (22). The universal joint (20) includes the first axle (202) and the second axle (204), which can swing freely. The first axle (202) is connected to the scheduled place of seat tube (102) of bicycle (10). The flexible components (220) in the twist apparatus (22) connects the second axle (204). The second axle (204) goes through at least one fixer (2040). The function of the fixer (2040) is to interfere with the connecting rod (2202), which is limited by the flexible component (220). The twist apparatus (22) is used to connect the second axle to the scheduled place of the connected bicycle (12), and then the reaction force can be reduced when riders on the tandem bicycle (1) make a turn on a rugged road.

The clip fixer (2020) in the first axle (202) is installed to the scheduled place of the seat tube (102).

The connected bicycle (12) can be equipped with plural wheels (120) (two, three, or above four wheels)

The expansion structure (122) is in the connected bicycle (12). The expansion structure (122) can fold or unfold the bicycle (12), and the distance between two wheels can also be adjusted by the device.

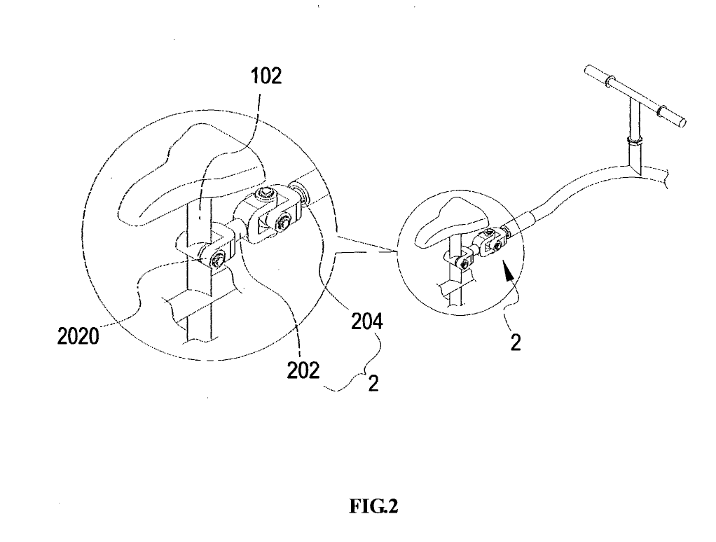

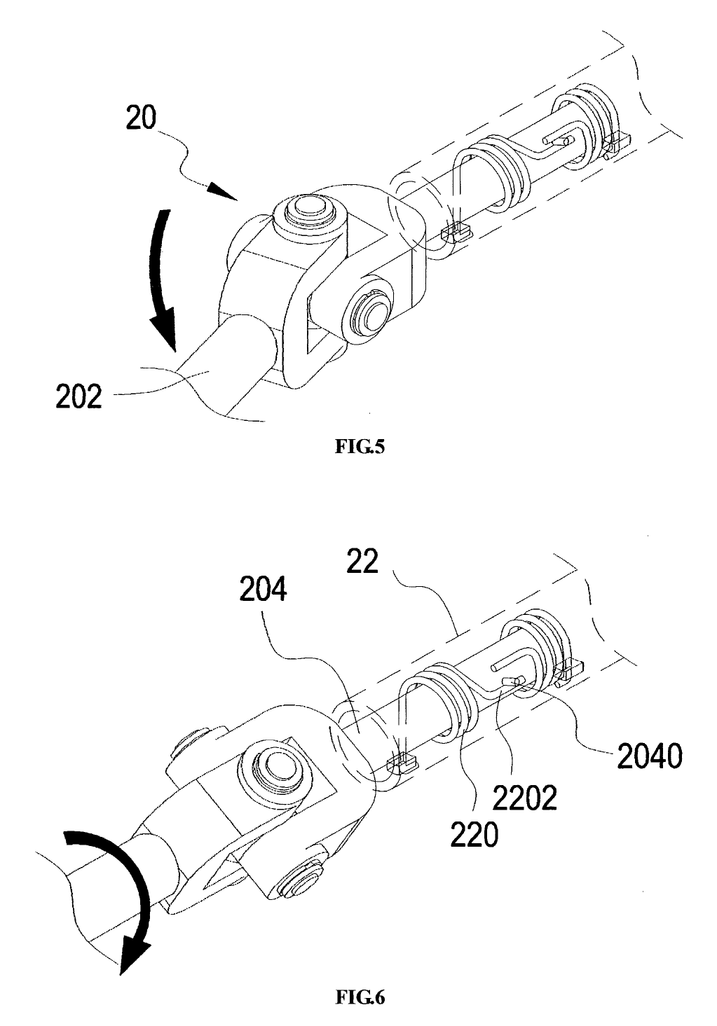

The tenons in the twist apparatus (22) are used to fix the flexible component (220) Based on the structure and design mentioned above, the detailed instruction of the use of the creation is as below, please also refer to the FIG. 5 and FIG. 6 at the same time. The FIG. 1 and FIG. 2 are the most optimum status of the execution of the creation, and there could be a clear understanding from the reference of FIG. 1. The stability, at the start or at low speed in riding, can be increased by the adapter device (2), which is installed to the seat tube (102) of bicycle (10) by the clip fixer (2020) in the first axle (202). The structure of universal join (20) in the first axle (202), around the seat tube (102), can eliminate the reaction force from the rugged roads to the tandem bicycle (1) when riders make a turn. About the twist apparatus (22), when riders make a turn under high speed, the fixers (2040) (the projecting column) in the second axle (204) can be used to interfere with the connecting rod (2202), which is limited by flexible component (220). Then, the rotating second axle (204) will be limited by the torque of flexible component (220), so the connected bicycle (12) can keep the stability to avoid rollover.

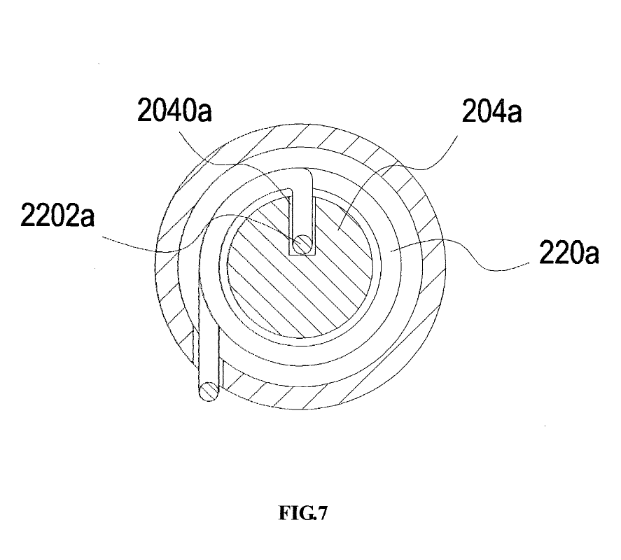

Please refer to the FIG. 7, its the section of another twist apparatus in the creation. The fixer (2040 a) (for example the groove) in the second axle (204a) is to fix the connecting rod (2202 a), which is limited by the flexible component (220 a), in the groove. And, at this moment, the rotating second axle (204a) will be limited by the torque of flexible component (220 a), so the connected bicycle (not shown on the drawing) can keep stable and avoid rollover or serious shake.

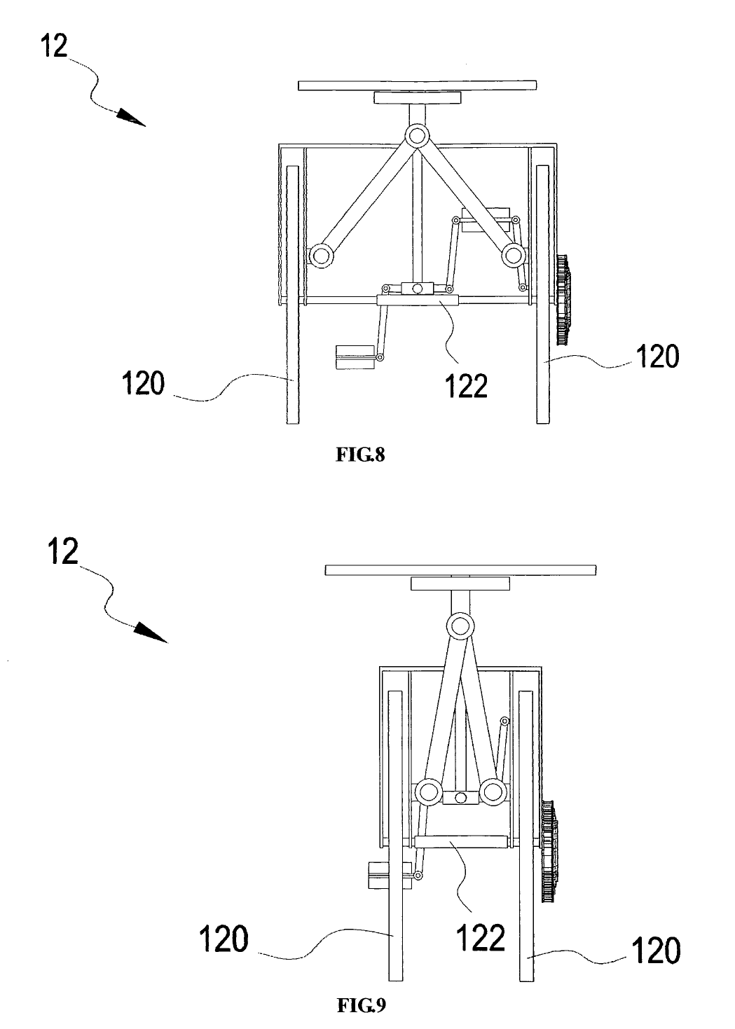

The FIG. 8 and FIG. 9 separately represent the folded and unfolded status of the whole bicycle, including the creation. There is an expansion structure (122) in the connected bicycle (12), and it can adjust the distance between the wheels on the two sides. If users would like to fold the connected bicycle (12), the expansion structure (122) can be employed to narrow the space that the connected bicycle (12) takes by adjusting the distance between the two wheels. On the other hand, the extension structure (122) can also be used to unfold the connected bicycle (12). Therefore, its easy to unfold and fold the device to reach to the purpose of saving space.

The description above is just the best status of the execution of the creation, and it won't limit the patent range of the creation. Based on the instruction or content in the figures of the creation, any applications from the modification of the creation should be included in the range of the patent.

In summary, the creative adapter device can really reach to its effectiveness and function in execution. This is a good and practical creation, which satisfies the requirement of patent, and so the application is submitted based on all related requirements.

What is claimed is:

1. This is an adapter device for tandem bicycle, which combines the one-seat bicycle and the connected bicycle. The adapter device includes the universal joint and the twist apparatus. The universal joint comprises the first axle and the second axle, which can swing freely. The first axle is connected to the scheduled place of seat tube. There are several flexible components in the twist apparatus to connect the second axle. The second axle goes through the fixers, and the fixers are used to interfere with the connecting rod, which is limited by flexible components. By means of the scheduled place when the twist apparatus link the connected bicycle, it can keep the stability of tandem bicycle at the start or at low speed in riding.

2. The adapter device according to claim 1, wherein the clip fixer in the first axle is used to fix the first axle to the scheduled place of seat tube.

3. The adapter device according to claim 1, wherein the connected bicycle has plural wheels.

4. The adapter device according to claim 1, wherein there is an expansion structure in the connected bicycle, and it can adjust the distance between the wheels on the two sides.

5. The adapter device according to claim 1, wherein the tenon in the twist apparatus is designed to fix the flexible component.
